(19) United States
(12) Patent Application Publication
(10) Pub. No.: US 2017/0083531 A1
(43) Pub. Date: Mar. 23, 2017

(54) SELECTING AN INCREMENTAL BACKUP APPROACH

(71) Applicant: EMC Corporation, Hopkinton, MA (US)

(72) Inventors: Friar Yangfeng Chen, Beijing (CN); Xin Zhong, Beijing (CN); Wei Qi, Beijing (CN); Wenxuan Yin, Beijing (CN)

(21) Appl. No.: 15/263,930

(22) Filed: Sep. 13, 2016

(30) Foreign Application Priority Data
Sep. 17, 2015 (CN) 2015105959599

(51) Int. Cl. G06F 17/30; G06F 11/14

(52) U.S. Cl. CPC G06F 17/30088; G06F 11/1451; G06F 11/1458; G06F 2201/805; G06F 2201/84

(57) ABSTRACT

Embodiments of the present disclosure provide a method and apparatus for selecting an incremental backup approach by selecting a portion of a current snapshot of a file system; comparing the selected portion with a portion in a historical snapshot of the file system to determine a changed data rate of the file system, wherein the portion of the historical snapshot corresponds to the selected portion; and selecting an incremental backup approach based on the changed data rate for a backup of the file system.

### RELATED APPLICATION

This application claim priority from Chinese Patent Application Number CN2015105959599, filed on Sep. 17, 2015 at the State Intellectual Property Office, China, titled “METHOD AND APPARATUS FOR SELECTING AN INCREMENTAL BACKUP APPROACH,” the contents of which is herein incorporated by reference in entirety.

### FIELD OF THE INVENTION

Embodiments of the present disclosure generally relate to incremental backup.

### BACKGROUND

Computer systems are constantly improving in terms of speed, reliability, and processing capability. As is known in the art, computer systems which process and store large amounts of data typically include a one or more processors in communication with a shared data storage system in which the data is stored. The data storage system may include one or more storage devices, usually of a fairly robust nature and useful for storage spanning various temporal requirements, e.g., disk drives. The one or more processors perform their respective operations using the storage system. Mass storage systems (MSS) typically include an array of a plurality of disks with on-board intelligent and communications electronics and software for making the data on the disks available.

Companies that sell data storage systems are very concerned with providing customers with an efficient data storage solution that minimizes cost while meeting customer data storage needs. It would be beneficial for such companies to have a way for reducing the complexity of implementing data storage.

### SUMMARY

Embodiments of the present disclosure propose a technical solution for determining a changed data rate of a file system as fast as possible so that an incremental backup approach is selected based on the changed data rate to back up the file system. According to one embodiment, there is provided a method for selecting an incremental backup approach that includes selecting a portion of a current snapshot of a file system; comparing the selected portion with a portion of a historical snapshot of the file system so as to determine a changed data rate of the file system, the portion of the historical snapshot corresponding to the selected portion; and selecting an incremental backup approach based on the changed data rate so as to back up the file system.

### BRIEF DESCRIPTION OF THE DRAWINGS

Through the detailed description of some embodiments of the present disclosure in the accompanying drawings, the features, advantages and other aspects of the present disclosure will become more apparent, wherein several embodiments of the present disclosure are shown for the illustration purpose only, rather than for limiting. In the accompanying drawings:

FIG. 1 shows a flowchart of a method for selecting an incremental backup approach according to an exemplary embodiment of the present disclosure;

FIG. 2 shows an exemplary comparison between a legacy incremental backup approach and a fast incremental backup approach by means of a curve graph;

FIG. 3 shows an exemplary comparison between a smart incremental backup approach according to the present invention, the legacy incremental backup approach and the fast incremental backup approach by means of a curve graph;

FIG. 4 shows a block diagram of an apparatus for selecting an incremental backup approach according to an exemplary embodiment of the present disclosure; and

FIG. 5 shows a block diagram of an exemplary computer system/server which is applicable to implement exemplary embodiments of the present disclosure.

Throughout the drawings, the same or corresponding reference numerals represent the same or corresponding parts

### DETAILED DESCRIPTION

Exemplary embodiments of the present disclosure will be described in detail with reference to figures. The flowcharts and block diagrams in the figures illustrate system architecture, functions and operations executable by a method and system according to the embodiments of the present disclosure. It should be appreciated that each block in the flowcharts or block diagrams may represent a module, a program segment, or a part of code, which contains one or more executable instructions for performing specified logic functions. It should also be noted that, in some alternative implementations, the functions noted in the block may occur out of the order noted in the figures. For example, two blocks shown consecutively may be performed in parallel substantially or in an inverse order, depending on involved functions. It should also be noted that each block in the block diagrams and/or flow charts and a combination of blocks in block diagrams and/or flow charts may be implemented by a dedicated hardware-based system for executing a prescribed function or operation or may be implemented by a combination of dedicated hardware and computer instructions.

The terms “comprising”, “including” and their variants used herein should be understood as open terms, i.e., “comprising/including, but not limited to”. The term “based on” means “at least partly based on”. The term “an embodiment” represents “at least one embodiment”; the terms “another embodiment” and “a further embodiment” represent “at least one additional embodiment”. Relevant definitions of other terms will be given in the description below.

According to one embodiment, a method for selecting an incremental backup approach includes selecting a portion of a current snapshot of a file system. In a further embodiment the method may include comparing a selected portion with a portion of a historical snapshot of the file system so as to determine a changed data rate of a file system, wherein a portion of the historical snapshot corresponding to a selected portion. A further embodiment of the method may include selecting an incremental backup approach based on a changed data rate so as to back up a file system.

Generally, incremental backup refers to a full backup for a file system or a backup for an incremental file since the last incremental backup. Typically, each incremental backup needs to back up files that have been added or modified since the last incremental backup. Typically, this means that an object of the first incremental backup may be files that have been added or modified since the full backup, and an object of the second incremental backup may be files that have been added or modified since the first incremental backup.

Generally, before a backup (either a full backup or an incremental backup) is started, a snapshot for a file system is created. Typically, a snapshot preserves the file system status at exactly a time when the backup is started, so as to prevent subsequent backups from being interfered by possible changes of a file system during the backup process. Traditionally, a backup runs over a snapshot instead of a file system directly. Thus, typically, when a backup of a file system is mentioned, in fact a backup operation takes place on a snapshot of a file system.

Traditionally, when a legacy incremental backup approach is adopted, the traditional incremental backup needs to traverse an entire file system and check each of files one by one, and then backs up the files if the incremental criteria (usually a timestamp) is met. In recent years, generally, a fast incremental backup approach has emerged. Conventionally, fast incremental backup detects differences between a current snapshot and a snapshot that was generated when a last backup was started, checks files from these detected differences, and then backs up the file if an incremental criteria (usually a timestamp) is met.

In some embodiments, selecting a portion of a current snapshot of a file system may include randomly selecting the portion of the current snapshot. In some embodiments, randomly selecting a portion of a current snapshot may include dividing data blocks in a current snapshot into a plurality of groups; and may further include randomly selecting a predetermined number of data blocks in each of a plurality of groups. In some embodiments, selecting a portion of the current snapshot of a file system may include dividing data blocks in a current snapshot into a plurality of groups; and may further include selecting one or more data blocks at a predetermined location in each of a plurality of groups.

In some embodiments, selecting an incremental backup approach based on a changed data rate so as to back up a file system may include comparing a changed data rate with a predetermined threshold. Some embodiment may include, in response to a changed data rate being greater than a predetermined threshold, selecting a legacy incremental backup approach to back up a file system. Some embodiments may include in response to a changed data rate being less than or equal to a predetermined threshold, selecting a fast incremental backup approach to back up a file system. In some embodiments, a predetermined threshold may be between 30% and 50%. In some embodiments, a selected portion may include 1% to 10% of a current snapshot.

According to one embodiment, an apparatus for selecting an incremental backup approach may include a selecting unit configured to select a portion of a current snapshot of a file system. In a further embodiment, the apparatus may include a comparing unit configured to compare a selected portion with a portion of a historical snapshot of a file system so as to determine a changed data rate of a file system, wherein a portion of a historical snapshot corresponding to a selected portion. In a further embodiment the apparatus may include a backup unit configured to select an incremental backup approach based on a changed data rate so as to back up a file system.

In some embodiments, the selecting unit may be further configured to randomly select a portion of a current snapshot. In some embodiments, a selecting unit may be further configured to: divide data blocks in a current snapshot into a plurality of groups; and may further include randomly select a predetermined number of data blocks in each of a plurality of groups. In some embodiments, selecting unit may be further configured to: divide data blocks in a current snapshot into a plurality of groups; and may select one or more data blocks at a predetermined location in each of a plurality of groups.

In some embodiments, backup unit may be further configured to compare changed data rate with a predetermined threshold; and in response to changed data rate being greater than a predetermined threshold, may be configured to select a legacy incremental backup approach to back up the file system; and in response to changed data rate being less than or equal to a predetermined threshold, may be configured to select a fast incremental backup approach to back up the file system. In some embodiments, a predetermined threshold may be between 30% and 50%. In some embodiments, a selected portion may include 1% to 10% of a current snapshot.

In one embodiment there is provided a computer program product that includes a computer readable medium that is carried on computer program code embodied therein and for use with a computer. In a further embodiment, the computer program code may include: code for selecting a portion of a current snapshot of a file system; code for comparing a selected portion with a portion of a historical snapshot of the file system so as to determine a changed data rate of a file system, wherein the portion of the historical snapshot corresponding to a selected portion; and code for selecting an incremental backup approach based on a changed data rate so as to back up a file system.

In one embodiment, a technical solution for selecting an appropriate incremental backup approach based on a changed data rate of a file system according to embodiments of the present disclosure may overcome respective limitations of a fast incremental backup approach and a legacy incremental backup approach under different scenarios (e.g., different changed data rates of a file system), which may help to achieve a better performance. In addition, embodiments of the present disclosure provide a manner with which a changed data rate of a file system may be determined as fast as possible so that a better backup performance may be obtained with little additional overhead.

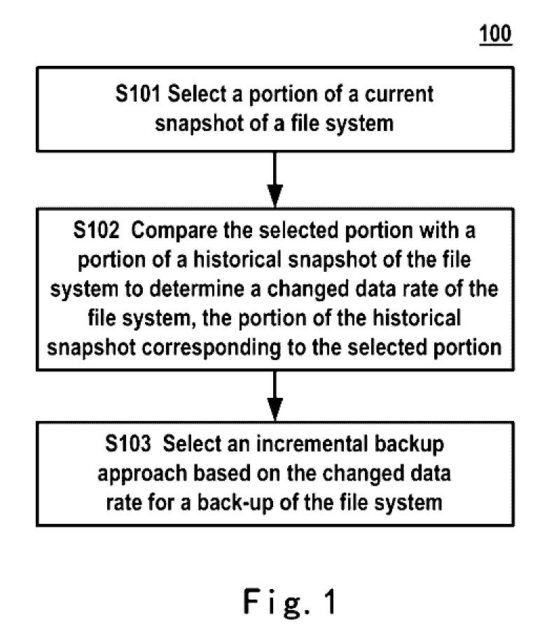

FIG. 1 shows a flowchart of a method 100 for selecting an incremental backup approach according to an embodiment of the present disclosure. As shown in FIG. 1, a portion of a current snapshot of a file system is selected in step S101. Next, in step S102, the selected portion is compared with a portion of a historical snapshot of the file system so as to determine a changed data rate of the file system, wherein the portion of the historical snapshot corresponds to the selected portion. In step S103, an incremental backup approach is selected based on the changed data rate so as to back up the file system. In this specification, “current snapshot of a file system” refers to a snapshot of the file system that is generated before the current backup for the file system is started, and the “historical snapshot of a file system” refers to a snapshot of the file system that is generated before the last backup for the file system is started.

In one embodiment, usually, it may be a time-wasting operation to compute the changed data rate of a file system. In a further embodiment, Table 1 blow is a test example for a file system with 1,000,000 files, each of which may be 32 KB in size.

TABLE 1

| Backup Type | Seconds | Time | Backup Files | Data Size |
|---|---|---|---|---|
| Full | 781 | 0:13:01 | 1,040,001 | 33 GB |
| 1% Incremental | 330 | 0:05:30 | 10,411 | 330 MB |

In one embodiment, as seen from the first row of Table 1, a full backup of a file system takes 781 seconds. In a further embodiment, as seen from the second row of Table 1, with only 1% data being changed, the time used by a legacy incremental backup amounts to as much as 330 seconds. In a further embodiment, this time may be divided into 2 parts: a file system traverse time and a real data input/output (I/O) time. In a general embodiment, a file system or a snapshot of a file system may contain two parts: a Mode area and a data area. In a further embodiment, for a purposed traversing of a file system or getting differences between snapshots, only an Mode area has to be focused on because the Mode area may contain metadata of a file for incremental criteria filtering and a data area may be used later for real I/O for backup. In a further embodiment, while traversing a file system or comparing differences between snapshots is mentioned, in fact it may refer to an Mode area traversing or comparison.

In the example embodiment as illustrated in Table 1, as data size is only 330 MB, real data I/O time may be only about 1% (around 8 seconds) of the time (781 seconds) used by the full backup, and the rest is file system traverse time, approximately 300 seconds. In a further embodiment, if a file system contains, for example, 20 million files, the file system traverse time may be around 6000 seconds. In a further embodiment, therefore, it may not be feasible to first calculate a changed data rate by traversing an entire file system or comparing all differences between current and historical snapshots of a file system, and then select an appropriate incremental backup approach.

Therefore, according embodiments of the present disclosure, only a portion of a current snapshot of a file system may be selected, a selected portion of the current snapshot may be compared with a corresponding portion of a historical snapshot of the file system so as to calculate a changed data rate of the selected portion of the current snapshot to the corresponding portion of the historical snapshot, and the calculated changed data rate may be used as a changed data rate of the file system. Accordingly embodiments of the present disclosure may provide an approach for determining a changed data rate of a file system as fast as possible.

In some embodiments, selecting a portion of a current snapshot of a file system may include dividing data blocks in the current snapshot into a plurality of groups; and selecting one or more data blocks at a predetermined location in each of the plurality of groups. In a further embodiment, since one or more data blocks at a predetermined location may be selected from each of the groups, this selection operation may also referred to as “even sampling” below. In a further embodiment, for the sake of description, operations of “selecting a portion of a current snapshot of a file system” and “comparing the selected portion with a portion of a historical snapshot of the file system so as to determine a changed data rate of the file system, wherein the portion of the historical snapshot corresponds to the selected portion” (i.e., steps S101 and S102 in FIG. 1) may also referred to as “sampling survey” operation, and a rate of a selected portion of a current snapshot to the current snapshot or a rate of the number of a selected data blocks to total number of data blocks in each group may be referred to as a “sampling rate”.

In some embodiments, sampling rate is between 1% and 10%. In an example embodiment, a sampling rate of 1% may be adopted. In a further embodiment, data blocks in a current snapshot may be divided into a plurality of groups and each group contains 100 data blocks, and then a first data block may be selected from the first group. In one embodiment, it should be understood the number of resulting groups may depend on a size of the file system. In a further embodiment, a first data block in a first group may be compared with a corresponding data block in a historical snapshot of a file system, so as to calculate a changed data rate of a first data block in the first group to a corresponding data block in the historical snapshot (abbreviated as a first changed data rate). In a further embodiment, a first data block is also selected from a second group, and a first data block in the second group may be compared with a corresponding data block in a historical snapshot of a file system, so as to calculate a changed data rate of the first data block in the second group to the corresponding data block in the historical snapshot (abbreviated as a second changed data rate), and so on, until changed data rates of the first data blocks in all groups to corresponding data blocks in the historical snapshot are calculated. In a further embodiment, an average of a first changed data rate, a second changed data rate, . . . , and a last changed data rate may be calculated, and the calculated average may be used as a changed data rate of a file system.

In a further embodiment, it may be understood that, no operation is performed on data blocks in each group that are not selected. In one embodiment, it should be understood that for purpose of illustration, description has been presented to the example that a first data block may be selected from each group when a sampling rate is 1%. In a further embodiment, a data block at any appropriate location may be selected from each group, such as the second, the third data block and the like, and the scope of the present disclosure is not limited in this regard.

Similarly, In one embodiment, a sampling rate of 2% may be adopted. casein a further embodiment, for example, the first two data blocks may be selected from a first group, and then the first two data blocks in the first group are compared with corresponding data blocks in a historical snapshot of the file system. In a further embodiment, in an “even sampling” approach as discussed above, one or more data block at a predetermined location may be selected from each group. In a further embodiment, a resulting changed data rate of a file system may be obviously higher or lower than a real value because it may be possible that selected data block(s) may have a highest or a lowest changed data rate.

In a further embodiment a “random sampling” approach in which selecting a portion of a current snapshot of a file system is proposed, which may include randomly selecting a portion of a current snapshot. In some embodiments, randomly selecting a portion of a current snapshot may include dividing data blocks in a current snapshot into a plurality of groups; and may further include randomly selecting a predetermined number of data blocks from each of the plurality of groups.

In a further embodiment, like “even sampling” approach, a sampling rate between 1% and 10% may be adopted in a random sampling approach. In an example embodiment, a sampling rate of 1% may be adopted. In a specific embodiment, like the “even sampling” approach, data blocks in a current snapshot may be divided into a plurality of groups, each of which contains 100 data blocks, and then a data block may be randomly selected from the first group. In a further embodiment, a randomly selected data block in a first group may be compared with a corresponding data block in a historical snapshot of a file system, so as to calculate a changed data rate of a randomly selected data block in a first group to a corresponding data block in a historical snapshot (abbreviated as a first changed data rate for short). In a further embodiment, a data block may also randomly be selected from a second group, and a randomly selected data block in a second group may be compared with a corresponding data block in a historical snapshot of a file system, so as to calculate a changed data rate of a randomly selected data block in a second group to a corresponding data block in a historical snapshot (abbreviated as a second changed data rate), and so on, until changed data rates of randomly selected data blocks in all groups to corresponding data blocks in a historical snapshot are calculated. In a further embodiment, an average of a first changed data rate, a second changed data rate, . . . , and last changed data rate may be calculated, and the calculated average may be used as a changed data rate of a file system.

In one embodiment, Table 2 below shows a test result of testing a file system with 1,000,000 files using the “random sampling” approach. In a further embodiment, in the test, real changed data rate varies between 1% and 99%, and sampling rate varies between 1% and 10%. In one embodiment, the first column (incremental rate) in Table 2 indicates how many files in a file system have actually changed, i.e., real changed data rate of a file system, and the second to the eleventh columns indicate changed data rates (wherein sampling rate is between 1% and 10%) of a file system that may be determined in a “random sampling” approach. In a further embodiment, by calculating a respective difference between each of the second to the eleventh columns and the first column, errors between changed data rates determined in the “random sampling” approach and real changed data rates of a file system may be obtained. In a further embodiment, the last column in Table 2 shows a resulting maximum positive error, and the second last column shows a resulting maximum negative error. In a further embodiment, a maximum of 100 maximum positive errors and a maximum of 100 maximum negative errors may be determined respectively, just as shown in the last row in Table 2. In a further embodiment, as seen from the last row in Table 2, changed data rate of a file system that is determined in the “random sampling” approach ranges between 96.93% and 102.6% of the real changed data rate of a file system. In a further embodiment, as seen from Table 2, in a “random sampling” approach, although a small amount of data may be sampled (sampling rate is between 1% and 10%), the changed data rate of a file system may be determined with higher accuracy.

TABLE 2

| Incremental | Sampling | Sampling | Sampling | Sampling | Sampling | Sampling | Sampling |
|---|---|---|---|---|---|---|---|
| Rate | Rate 1% | Rate 2% | Rate 3% | Rate 4% | Rate 5% | Rate 6% | Rate 7% |
| 1.0000% | 0.9880% | 1.0125% | 0.9863% | 1.0030% | 0.9788% | 0.9942% | 1.0059% |
| 2.0000% | 2.0540% | 2.0380% | 1.9520% | 2.0425% | 1.9954% | 2.0088% | 2.0156% |
| 3.0000% | 3.0720% | 2.9480% | 2.9730% | 2.9760% | 2.9890% | 2.9982% | 3.0036% |
| 4.0000% | 3.8770% | 4.0325% | 4.0110% | 4.0015% | 4.0244% | 3.9922% | 3.9960% |
| 5.0000% | 5.0520% | 5.0445% | 5.0700% | 4.9913% | 5.0176% | 5.0053% | 5.0259% |
| 6.0000% | 5.9500% | 6.0580% | 6.0437% | 5.9785% | 6.0424% | 6.0230% | 6.0027% |
| 7.0000% | 7.0990% | 6.9630% | 7.0613% | 6.9743% | 6.9996% | 6.9800% | 7.0423% |
| 8.0000% | 8.0190% | 8.0585% | 8.0420% | 7.9525% | 8.0262% | 7.9958% | 7.9717% |
| 9.0000% | 8.8810% | 9.1140% | 8.9373% | 9.0723% | 9.0186% | 9.0290% | 9.0627% |
| 10.0000% | 10.0190% | 9.8865% | 10.0733% | 10.0418% | 9.9300% | 9.9392% | 9.9960% |
| 11.0000% | 11.0660% | 10.9595% | 10.9243% | 11.0090% | 10.9610% | 11.0167% | 10.9671% |
| 12.0000% | 12.1410% | 11.9885% | 12.0063% | 11.9890% | 11.9630% | 12.0392% | 11.9987% |
| 13.0000% | 13.0060% | 12.9310% | 13.0233% | 13.1290% | 12.9946% | 13.0083% | 13.0051% |
| 14.0000% | 14.0220% | 14.0015% | 14.0807% | 14.0285% | 13.9684% | 14.0467% | 14.0817% |
| 15.0000% | 14.9410% | 15.0080% | 14.9943% | 14.9930% | 14.9524% | 14.9670% | 14.9840% |
| 16.0000% | 15.8740% | 16.0735% | 16.0013% | 15.8860% | 16.0098% | 15.9520% | 15.9961% |
| 17.0000% | 16.9870% | 16.9565% | 16.9677% | 17.0367% | 17.0954% | 16.9827% | 17.0246% |
| 18.0000% | 18.2380% | 17.9090% | 18.0060% | 18.0817% | 18.0304% | 17.9212% | 17.9739% |
| 19.0000% | 19.0230% | 19.0160% | 18.9763% | 19.0590% | 18.9984% | 19.0053% | 19.0039% |
| 20.0000% | 19.8040% | 20.0820% | 19.9677% | 19.9992% | 19.9340% | 20.0043% | 19.9746% |
| 21.0000% | 20.9210% | 21.0455% | 20.8917% | 20.9927% | 20.9370% | 21.0093% | 20.9526% |
| 22.0000% | 21.8010% | 22.1615% | 22.0670% | 22.0425% | 22.0064% | 21.9422% | 22.0196% |
| 23.0000% | 23.0810% | 22.9590% | 22.9433% | 22.8893% | 22.8892% | 23.0245% | 23.0416% |
| 24.0000% | 23.9600% | 23.9890% | 24.0883% | 23.9977% | 24.0470% | 23.9728% | 23.8734% |
| 25.0000% | 24.9540% | 25.0940% | 24.9990% | 25.0380% | 25.0304% | 25.0802% | 25.0549% |
| 26.0000% | 25.9800% | 26.1715% | 25.9407% | 26.0752% | 25.9544% | 26.0037% | 25.9804% |
| 27.0000% | 27.1140% | 27.1500% | 26.9607% | 26.9205% | 27.0568% | 27.0052% | 26.9686% |
| 28.0000% | 28.0290% | 28.0340% | 27.9233% | 27.9615% | 27.9518% | 27.9805% | 28.0029% |
| 29.0000% | 28.5750% | 29.0985% | 28.8923% | 29.0130% | 29.1766% | 28.9633% | 28.9494% |
| 30.0000% | 29.8060% | 29.9205% | 29.9257% | 30.0162% | 30.0418% | 30.0202% | 30.0443% |
| 31.0000% | 31.0300% | 31.1425% | 30.9640% | 31.0105% | 31.0096% | 30.9328% | 31.0730% |
| 32.0000% | 32.1340% | 32.0210% | 31.9913% | 31.8792% | 31.9718% | 32.0525% | 31.9591% |
| 33.0000% | 32.9600% | 33.2165% | 33.0693% | 32.9850% | 33.0164% | 33.0202% | 33.0211% |
| 34.0000% | 34.2890% | 34.0295% | 33.9103% | 33.9743% | 33.9940% | 33.9708% | 33.9569% |
| 35.0000% | 35.2350% | 35.0945% | 34.9197% | 34.9100% | 34.9684% | 35.0277% | 34.9974% |
| 36.0000% | 36.1870% | 36.0645% | 35.9990% | 35.9295% | 36.0756% | 35.9917% | 35.9629% |
| 37.0000% | 36.8150% | 36.9815% | 36.9377% | 37.0813% | 36.9974% | 37.1172% | 36.9111% |
| 38.0000% | 38.2100% | 38.0165% | 38.0147% | 37.9667% | 37.9842% | 38.0128% | 37.9351% |
| 39.0000% | 38.7840% | 39.0015% | 39.0530% | 38.9405% | 38.8928% | 39.0688% | 38.9944% |
| 40.0000% | 40.1230% | 39.9655% | 40.0720% | 39.9570% | 39.9220% | 39.8967% | 40.0804% |
| 41.0000% | 41.0470% | 40.9810% | 41.0850% | 40.9135% | 40.8374% | 40.9557% | 41.0571% |
| 42.0000% | 42.0790% | 42.0145% | 42.0407% | 41.9090% | 42.0982% | 42.0635% | 41.9460% |
| 43.0000% | 42.8270% | 42.8805% | 42.9797% | 42.9942% | 43.0086% | 43.0102% | 43.0234% |
| 44.0000% | 44.2480% | 44.0620% | 44.0540% | 43.9990% | 43.9590% | 44.0322% | 43.9543% |
| 45.0000% | 44.8830% | 45.0955% | 44.9817% | 44.9215% | 44.9100% | 44.9915% | 45.0261% |
| 46.0000% | 45.9480% | 45.9470% | 46.0377% | 46.1400% | 46.0960% | 46.0408% | 45.9700% |
| 47.0000% | 46.9920% | 47.0935% | 46.9820% | 47.0320% | 47.0224% | 47.0273% | 47.0583% |
| 48.0000% | 48.1570% | 48.0835% | 48.0727% | 48.0125% | 47.9084% | 48.0123% | 48.0104% |
| 49.0000% | 48.9110% | 48.9260% | 49.1293% | 49.0413% | 49.0524% | 48.9972% | 48.9974% |
| 50.0000% | 50.0040% | 49.8765% | 50.0003% | 50.0398% | 50.0518% | 49.9860% | 49.9053% |
| 51.0000% | 51.0550% | 51.0685% | 51.0553% | 51.0238% | 51.1248% | 51.0573% | 50.8906% |
| 52.0000% | 51.8520% | 51.9765% | 52.1617% | 51.9350% | 52.0488% | 51.9263% | 51.9389% |
| 53.0000% | 52.7780% | 52.9695% | 53.1003% | 52.9768% | 52.9412% | 53.0518% | 52.9677% |
| 54.0000% | 53.7580% | 54.0335% | 53.9160% | 54.0563% | 53.9338% | 53.9337% | 53.9804% |
| 55.0000% | 54.9990% | 55.1865% | 54.9410% | 55.1675% | 54.9842% | 54.9707% | 54.8753% |
| 56.0000% | 56.0030% | 56.0280% | 56.1410% | 55.9992% | 55.9842% | 56.0397% | 55.9989% |
| 57.0000% | 56.9240% | 57.1310% | 57.0300% | 56.9557% | 56.9544% | 56.9840% | 57.0741% |
| 58.0000% | 57.8010% | 57.8750% | 57.9423% | 58.0410% | 57.9848% | 57.9915% | 58.1750% |
| 59.0000% | 59.2010% | 59.1105% | 59.0067% | 59.0163% | 59.0858% | 58.9847% | 59.0339% |
| 60.0000% | 59.6850% | 59.9735% | 60.1730% | 59.9707% | 60.0020% | 59.9437% | 60.0477% |
| 61.0000% | 61.0820% | 60.9220% | 61.1390% | 61.0140% | 61.0578% | 61.0517% | 61.0909% |
| 62.0000% | 61.9410% | 62.1215% | 62.0407% | 62.1460% | 62.0516% | 62.0068% | 61.8321% |
| 63.0000% | 62.9570% | 62.9645% | 62.9403% | 62.9785% | 63.0290% | 62.8462% | 63.0354% |
| 64.0000% | 64.1550% | 63.9540% | 63.8240% | 63.8788% | 63.9288% | 64.0175% | 63.9559% |
| 65.0000% | 65.0320% | 65.0045% | 64.9667% | 64.9538% | 64.9864% | 64.9720% | 64.9049% |
| 66.0000% | 66.1230% | 66.0990% | 65.9230% | 65.9865% | 66.0184% | 65.9447% | 66.0703% |
| 67.0000% | 66.8800% | 66.8900% | 66.9590% | 66.9145% | 67.0066% | 67.0695% | 67.0343% |
| 68.0000% | 68.2850% | 67.9170% | 67.9777% | 68.0135% | 67.9804% | 67.9623% | 67.7917% |
| 69.0000% | 68.5470% | 69.0600% | 68.9940% | 68.9235% | 69.0034% | 69.0375% | 68.9809% |
| 70.0000% | 70.0020% | 69.9605% | 69.9310% | 70.0037% | 69.9888% | 70.0890% | 70.0251% |
| 71.0000% | 71.0340% | 70.8205% | 70.9737% | 71.0018% | 70.9568% | 71.0665% | 70.8986% |
| 72.0000% | 71.6040% | 71.9320% | 72.0507% | 71.8765% | 71.9578% | 72.0152% | 72.0287% |
| 73.0000% | 73.3180% | 72.9645% | 72.9690% | 73.1332% | 73.0362% | 73.0100% | 72.9376% |
| 74.0000% | 74.1300% | 73.8675% | 73.8997% | 73.9142% | 73.9330% | 73.9280% | 74.0509% |
| 75.0000% | 74.9580% | 75.0175% | 75.0163% | 75.0308% | 75.0392% | 74.9143% | 75.0359% |
| 76.0000% | 76.1090% | 75.9080% | 75.9870% | 75.9983% | 75.9422% | 76.0063% | 75.9757% |
| 77.0000% | 77.1680% | 76.9755% | 77.1203% | 77.0513% | 76.8922% | 77.0263% | 77.0674% |
| 78.0000% | 78.0300% | 77.9540% | 78.1020% | 77.8593% | 78.0146% | 78.0152% | 78.0239% |
| 79.0000% | 79.0710% | 78.9145% | 79.0173% | 78.9810% | 78.8922% | 79.0315% | 79.0513% |
| 80.0000% | 80.0440% | 80.0920% | 80.0490% | 80.0650% | 79.9756% | 80.0148% | 80.0416% |
| 81.0000% | 81.0720% | 81.1355% | 80.9117% | 81.0495% | 81.0058% | 81.0770% | 81.0376% |
| 82.0000% | 81.9800% | 81.9985% | 81.9163% | 82.0230% | 81.9154% | 82.0635% | 82.0214% |
| 83.0000% | 82.9290% | 83.1375% | 83.0857% | 82.9730% | 82.9742% | 82.9530% | 82.9477% |
| 84.0000% | 84.1070% | 83.9310% | 83.9257% | 83.9750% | 84.0790% | 83.9775% | 84.0204% |
| 85.0000% | 85.0200% | 85.0490% | 85.1197% | 84.9598% | 85.0350% | 85.0470% | 84.9846% |
| 86.0000% | 86.0340% | 86.0045% | 86.0230% | 85.9937% | 85.9932% | 85.9650% | 85.9594% |
| 87.0000% | 87.0370% | 86.9355% | 87.0560% | 86.9100% | 86.9820% | 86.9698% | 86.9857% |
| 88.0000% | 87.9970% | 87.9675% | 88.0260% | 88.0422% | 87.9572% | 87.9930% | 87.9689% |
| 89.0000% | 88.9110% | 89.0855% | 88.9833% | 88.9772% | 88.9728% | 89.0090% | 88.9454% |
| 90.0000% | 90.0500% | 90.0510% | 90.0440% | 90.0168% | 89.9916% | 89.9873% | 90.0470% |
| 91.0000% | 90.8790% | 91.1525% | 91.0107% | 90.9255% | 91.0702% | 91.0183% | 91.0126% |
| 92.0000% | 92.1610% | 92.1135% | 92.1443% | 91.9825% | 92.0218% | 91.9680% | 91.9817% |
| 93.0000% | 92.8670% | 92.9485% | 92.9000% | 92.9213% | 92.9908% | 92.9958% | 93.0257% |
| 94.0000% | 94.0400% | 93.9555% | 94.0483% | 93.9493% | 94.0096% | 93.9500% | 93.9989% |
| 95.0000% | 95.0210% | 94.9805% | 94.9183% | 94.9920% | 94.9880% | 94.9880% | 95.0134% |
| 96.0000% | 96.0330% | 95.9595% | 95.9523% | 96.0132% | 96.0588% | 96.0362% | 95.9884% |
| 97.0000% | 97.0310% | 97.0075% | 96.9350% | 97.0125% | 96.9832% | 97.0340% | 97.0226% |
| 98.0000% | 98.0880% | 98.0480% | 98.0107% | 98.0017% | 98.0048% | 97.9818% | 97.9961% |
| 99.0000% | 98.9800% | 99.0425% | 98.9783% | 98.9682% | 99.0100% | 99.0035% | 99.0039% |

| Incremental | Sampling | Sampling | Sampling | Max Negative | Max Positive |
|---|---|---|---|---|---|
| Rate | Rate 8% | Rate 9% | Rate 10% | Error | Error |
| 1.0000% | 0.9936% | 1.0080% | 1.0167% | −2.1200% | 1.6903% |
| 2.0000% | 1.9865% | 2.0263% | 1.9953% | −2.4000% | 2.6290% |
| 3.0000% | 2.9689% | 3.0001% | 3.0002% | −1.7333% | 2.3438% |
| 4.0000% | 4.0086% | 3.9737% | 3.9812% | −3.0750% | 0.8383% |
| 5.0000% | 4.9770% | 4.9752% | 4.9807% | −0.4960% | 1.3856% |
| 6.0000% | 5.9986% | 6.0024% | 5.9904% | −0.8333% | 0.9748% |
| 7.0000% | 6.9800% | 7.0492% | 6.9849% | −0.5286% | 1.3946% |
| 8.0000% | 8.0376% | 8.0307% | 8.0707% | −0.5938% | 0.8817% |
| 9.0000% | 8.9724% | 8.9963% | 8.9879% | −1.3222% | 1.2836% |
| 10.0000% | 9.9202% | 10.0129% | 9.9967% | −1.1350% | 0.7316% |
| 11.0000% | 10.9866% | 11.0303% | 11.0095% | −0.6882% | 0.5964% |
| 12.0000% | 12.0092% | 12.0067% | 12.0047% | −0.3083% | 1.1614% |
| 13.0000% | 13.0054% | 12.9894% | 12.9475% | −0.5308% | 0.9918% |
| 14.0000% | 13.9814% | 13.9922% | 13.9798% | −0.2257% | 0.5827% |
| 15.0000% | 14.9734% | 15.0013% | 14.9826% | −0.3933% | 0.0535% |
| 16.0000% | 15.9727% | 16.0400% | 16.0409% | −0.7875% | 0.4630% |
| 17.0000% | 16.9751% | 17.0827% | 17.0040% | −0.2559% | 0.5616% |
| 18.0000% | 18.0195% | 18.0336% | 18.0122% | −0.5056% | 1.3050% |
| 19.0000% | 18.9637% | 19.0312% | 18.9686% | −0.1911% | 0.3102% |
| 20.0000% | 20.0484% | 19.9493% | 20.0483% | −0.9800% | 0.4141% |
| 21.0000% | 20.9674% | 21.0230% | 20.9906% | −0.5157% | 0.2175% |
| 22.0000% | 22.0546% | 21.9862% | 21.9940% | −0.9045% | 0.7408% |
| 23.0000% | 23.0338% | 22.8711% | 23.0283% | −0.5604% | 0.3509% |
| 24.0000% | 23.9726% | 23.9629% | 24.0351% | −0.5275% | 0.3685% |
| 25.0000% | 24.9851% | 24.9956% | 24.9992% | −0.1840% | 0.3767% |
| 26.0000% | 26.0571% | 25.9914% | 25.9959% | −0.2281% | 0.6601% |
| 27.0000% | 27.0103% | 27.0953% | 26.9399% | −0.2944% | 0.5532% |
| 28.0000% | 28.0175% | 28.0387% | 28.0417% | −0.2739% | 0.1488% |
| 29.0000% | 28.9528% | 29.0503% | 29.0035% | −1.4655% | 0.6180% |
| 30.0000% | 30.0317% | 30.0336% | 29.9757% | −0.6467% | 0.1486% |
| 31.0000% | 31.0396% | 30.9866% | 30.9780% | −0.2168% | 0.4592% |
| 32.0000% | 32.0071% | 32.0346% | 31.9439% | −0.3775% | 0.4170% |
| 33.0000% | 33.1028% | 33.0138% | 32.9200% | −0.2424% | 0.6569% |
| 34.0000% | 34.0061% | 33.9022% | 34.0321% | −0.2876% | 0.8428% |
| 35.0000% | 34.9664% | 34.9670% | 35.0200% | −0.2571% | 0.6670% |
| 36.0000% | 35.9789% | 36.0012% | 35.9521% | −0.1958% | 0.5168% |
| 37.0000% | 36.9718% | 36.9449% | 37.0316% | −0.5000% | 0.3183% |
| 38.0000% | 38.0029% | 38.0206% | 37.8895% | −0.2908% | 0.5496% |
| 39.0000% | 38.9934% | 38.9714% | 39.0136% | −0.5538% | 0.1774% |
| 40.0000% | 39.9955% | 40.0281% | 39.9657% | −0.2583% | 0.3066% |
| 41.0000% | 41.0628% | 40.9877% | 40.9895% | −0.3966% | 0.2071% |
| 42.0000% | 42.0776% | 41.9856% | 42.0652% | −0.2167% | 0.2334% |
| 43.0000% | 42.9954% | 42.9928% | 43.0282% | −0.4023% | 0.0658% |
| 44.0000% | 43.9870% | 43.9617% | 43.9399% | −0.1366% | 0.5605% |
| 45.0000% | 45.0551% | 44.9418% | 45.0283% | −0.2600% | 0.2128% |
| 46.0000% | 46.0083% | 46.0250% | 46.0710% | −0.1152% | 0.3047% |
| 47.0000% | 46.9901% | 46.9484% | 47.0760% | −0.1098% | 0.1990% |
| 48.0000% | 47.9712% | 48.0206% | 48.0517% | −0.1908% | 0.3260% |
| 49.0000% | 49.0674% | 49.1256% | 49.0068% | −0.1816% | 0.2644% |
| 50.0000% | 49.9518% | 49.9603% | 50.0124% | −0.2470% | 0.1036% |
| 51.0000% | 50.9479% | 50.8858% | 50.9613% | −0.2239% | 0.2444% |
| 52.0000% | 52.0395% | 51.9386% | 51.8747% | −0.2846% | 0.3118% |
| 53.0000% | 53.0158% | 53.0198% | 52.9552% | −0.4189% | 0.1900% |
| 54.0000% | 53.9404% | 53.9808% | 54.0043% | −0.4481% | 0.1047% |
| 55.0000% | 54.9878% | 54.9889% | 54.9421% | −0.2267% | 0.3391% |
| 56.0000% | 55.9780% | 56.0082% | 56.0265% | −0.0393% | 0.2518% |
| 57.0000% | 56.9539% | 56.9911% | 57.0114% | −0.1333% | 0.2301% |
| 58.0000% | 57.9400% | 58.0320% | 58.0884% | −0.3431% | 0.3028% |
| 59.0000% | 59.0465% | 58.9457% | 59.0133% | −0.0920% | 0.3395% |
| 60.0000% | 60.0150% | 59.9838% | 59.9974% | −0.5250% | 0.2899% |
| 61.0000% | 61.0389% | 60.9643% | 61.0018% | −0.1279% | 0.2276% |
| 62.0000% | 61.9790% | 62.0064% | 62.0094% | −0.2708% | 0.2357% |
| 63.0000% | 63.0302% | 62.9688% | 62.9532% | −0.2441% | 0.0562% |
| 64.0000% | 64.0095% | 63.9404% | 63.9972% | −0.2750% | 0.2416% |
| 65.0000% | 64.9835% | 65.0061% | 65.0200% | −0.1463% | 0.0492% |
| 66.0000% | 65.9977% | 66.0067% | 65.9746% | −0.1167% | 0.1860% |
| 67.0000% | 66.9537% | 67.0410% | 66.9781% | −0.1791% | 0.1039% |
| 68.0000% | 67.9531% | 68.0340% | 68.1061% | −0.3063% | 0.4174% |
| 69.0000% | 69.1369% | 68.9879% | 69.0753% | −0.6565% | 0.1997% |
| 70.0000% | 70.0678% | 69.9870% | 70.0200% | −0.0986% | 0.1271% |
| 71.0000% | 71.0579% | 70.9947% | 71.0379% | −0.2528% | 0.0936% |
| 72.0000% | 72.0483% | 72.0443% | 71.9979% | −0.5500% | 0.0708% |
| 73.0000% | 73.0116% | 72.9879% | 73.0159% | −0.0855% | 0.4337% |
| 74.0000% | 74.0814% | 73.9873% | 74.0667% | −0.1791% | 0.1754% |
| 75.0000% | 74.9284% | 74.9190% | 74.9804% | −0.1143% | 0.0523% |
| 76.0000% | 75.9951% | 76.0006% | 76.0108% | −0.1211% | 0.1432% |
| 77.0000% | 76.8780% | 76.9680% | 77.0691% | −0.1584% | 0.2177% |
| 78.0000% | 77.9621% | 78.0438% | 78.0135% | −0.1804% | 0.1307% |
| 79.0000% | 78.9801% | 78.9716% | 78.9335% | −0.1365% | 0.0898% |
| 80.0000% | 80.0412% | 79.9778% | 80.0542% | −0.0305% | 0.1149% |
| 81.0000% | 80.9615% | 80.9556% | 81.0062% | −0.1090% | 0.1671% |
| 82.0000% | 81.9894% | 81.9674% | 81.9808% | −0.1032% | 0.0775% |
| 83.0000% | 82.9332% | 82.9708% | 83.0436% | −0.0855% | 0.1658% |
| 84.0000% | 84.0016% | 83.9606% | 84.0302% | −0.0885% | 0.1272% |
| 85.0000% | 85.0415% | 85.0466% | 84.9795% | −0.0473% | 0.1408% |
| 86.0000% | 86.0279% | 85.9948% | 86.0486% | −0.0472% | 0.0565% |
| 87.0000% | 87.0024% | 86.9917% | 86.9655% | −0.1034% | 0.0643% |
| 88.0000% | 87.9371% | 87.9768% | 87.9515% | −0.0715% | 0.0480% |
| 89.0000% | 89.0270% | 89.0703% | 89.0420% | −0.1000% | 0.0962% |
| 90.0000% | 89.9311% | 90.0084% | 89.9674% | −0.0766% | 0.0566% |
| 91.0000% | 91.0487% | 91.0432% | 91.0536% | −0.1330% | 0.1678% |
| 92.0000% | 92.0331% | 92.0049% | 91.9645% | −0.0386% | 0.1747% |
| 93.0000% | 93.0197% | 93.0190% | 92.9642% | −0.1430% | 0.0277% |
| 94.0000% | 94.0077% | 94.0094% | 94.0210% | −0.0539% | 0.0514% |
| 95.0000% | 94.9957% | 95.0037% | 95.0008% | −0.0860% | 0.0221% |
| 96.0000% | 96.0216% | 95.9761% | 95.9836% | −0.0497% | 0.0612% |
| 97.0000% | 97.0123% | 96.9804% | 96.9897% | −0.0670% | 0.0350% |
| 98.0000% | 97.9944% | 97.9891% | 98.0047% | −0.0186% | 0.0897% |
| 99.0000% | 99.0036% | 98.9906% | 99.0023% | −0.0321% | 0.0429% |
| | | | | −3.0750% | 2.6290% |

Still with reference to FIG. 1, in step S103, an incremental backup approach is selected based on the changed data rate so as to back up the file system. In some embodiments, selecting an incremental backup approach based on a changed data rate so as to back up a file system may include comparing a changed data rate with a predetermined threshold. A further embodiment may include in response to a changed data rate being greater than a predetermined threshold, selecting a legacy incremental backup approach to back up a file system. A further embodiment may include in response to a changed data rate being less than or equal to a predetermined threshold, selecting a fast incremental backup approach to back up the file system. In some embodiments, a predetermined threshold may be between 30% and 50%.

In one embodiment, Table 3 below shows respective test results of testing a file system with 1,000,000 files, each of which is 32 KB in size, in a legacy incremental backup approach and a fast incremental backup approach.

TABLE 3

| Changed | Sec- | | | | | | |
|---|---|---|---|---|---|---|---|
| Data | onds | | Time | | | | |
| Rate | (Leg- | Seconds | (Leg- | Time | Backup | | |
| (%) | acy) | (Fast) | acy) | (Fast) | Files | File Size | |
| Full | 781 | N/A | 0:13:01 | N/A | 1,040,001 | 33 | GB |
| 1 | 330 | 18 | 0:05:30 | 0:00:18 | 10,411 | 330 | MB |
| 5 | 373 | 91 | 0:06:13 | 0:01:31 | 52,001 | 1650 | MB |
| 10 | 402 | 169 | 0:06:42 | 0:02:49 | 104,001 | 3300 | MB |
| 15 | 420 | 212 | 0:07:00 | 0:03:32 | 156,001 | 4950 | MB |
| 20 | 447 | 264 | 0:07:27 | 0:04:24 | 208,001 | 6600 | MB |
| 25 | 455 | 323 | 0:07:35 | 0:05:23 | 260,001 | 8250 | MB |
| 30 | 483 | 400 | 0:08:03 | 0:06:40 | 312,001 | 9900 | MB |
| 35 | 499 | 446 | 0:08:19 | 0:07:26 | 364,001 | 11 | GB |
| 40 | 538 | 506 | 0:08:58 | 0:08:26 | 416,001 | 13 | GB |
| 45 | 579 | 591 | 0:09:39 | 0:09:51 | 468,001 | 14 | GB |
| 50 | 576 | 676 | 0:09:36 | 0:11:16 | 520,001 | 16 | GB |
| 55 | 594 | 722 | 0:09:54 | 0:12:02 | 572,001 | 18 | GB |
| 60 | 619 | 743 | 0:10:19 | 0:12:23 | 624,001 | 19 | GB |
| 65 | 642 | 825 | 0:10:42 | 0:13:45 | 676,001 | 21 | GB |
| 70 | 675 | 906 | 0:11:15 | 0:15:06 | 728,001 | 23 | GB |
| 75 | 679 | 935 | 0:11:19 | 0:15:35 | 780,001 | 24 | GB |
| 80 | 705 | 1,034 | 0:11:45 | 0:17:14 | 832,001 | 26 | GB |
| 85 | 716 | 1,049 | 0:11:56 | 0:17:29 | 884,001 | 28 | GB |
| 90 | 778 | 1,127 | 0:12:58 | 0:18:47 | 936,001 | 29 | GB |
| 95 | 770 | 1,172 | 0:12:50 | 0:19:32 | 988,001 | 31 | GB |
| 100 | 777 | 1,276 | 0:12:57 | 0:21:16 | 1,040,001 | 33 | GB |

In a further embodiment involving a test, first a full backup may run on a file system, so that a time used for running a full backup may be obtained as shown in the second row of Table 3. In a further embodiment, a certain number of files in a file system may be changed, and the changed data rate may be between 1% and 100%. In an example embodiment, for a changed data rate of 1%, actually 10,000 files may be changed, as shown in the third row, the second column from the right of Table 3.

In a further embodiment, as seen from Table 3, as the changed data rate of a file system increases, speed of a fast incremental backup may slow down. In a further embodiment, when the changed data rate of a file system is less than or equal to 40%, a fast incremental back may cost less time than a legacy incremental backup. In a further embodiment, when the changed data rate of a file system is more than 40%, for example, amounts to 45%, the case reverses, i.e., a fast incremental backup may cost more time than a legacy incremental backup.

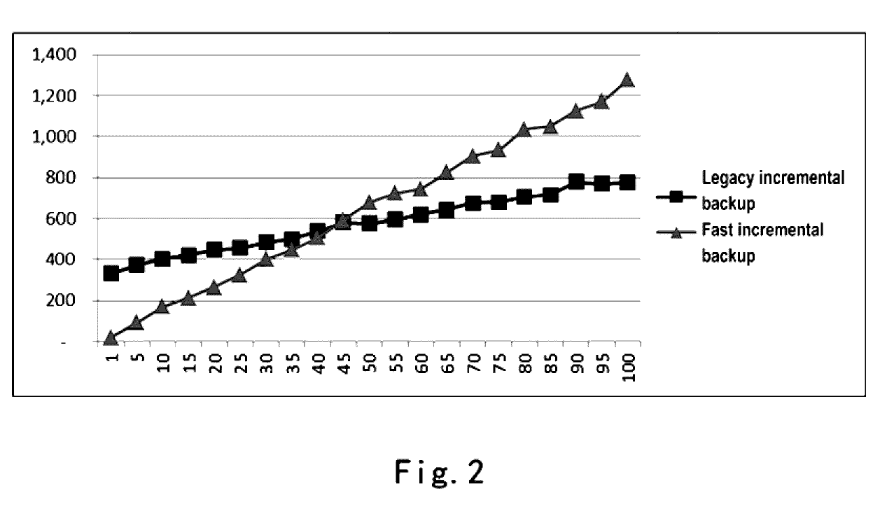

In relation to Table 3, FIG. 2 shows a comparison between a legacy incremental backup approach and a fast incremental backup approach by means of a curve graph. In FIG. 2, the horizontal axis represents a changed data rate of a file system, and the vertical axis represents time cost by a backup. As seen from FIG. 2, if a file system contains a large number of files (e.g., 10,000 files) and only a few files have been changed (e.g., added or modified) since a last backup, a fast incremental backup will present a better performance because the fast incremental backup may not have to traverse the whole file system. However, if a file system contains a large number of files and many files have been changed since a last backup, a legacy incremental backup may present a better performance. Specifically, as seen from FIG. 2, if the changed data rate of a file system is less than or equal to a predetermined threshold (e.g., 40%), a fast incremental backup approach may have a better performance than a legacy incremental backup; and if the changed data rate of a file system is greater than a predetermined threshold (e.g., 40%), a legacy incremental backup approach may have a better performance than a fast incremental backup. In a further embodiment, it may be seen that as for a legacy incremental backup approach, whatever the changed data rate is, a startup time is a bit long, but a total backup time and a changed data rate may be linearly-correlated. For a fast incremental backup approach, its startup time may be rather short, and at a same time, a total backup time increases a high speed.

As seen from Table 3 and FIG. 2, a fast incremental backup approach and a legacy incremental backup approach have their respective limitations in different scenarios (e.g., different changed data rates of a file system). Therefore, by selecting an appropriate incremental backup approach based on the changed data rate of a file system, it will help to obtain a better performance. In this specification, an incremental backup approach according to embodiments of the present disclosure may also be referred to as “smart incremental backup” approach.

In on embodiment, time spent by performing a “sampling survey” operation (hereinafter abbreviated as “sampling survey time”) may be further computed from examples in Table 3. In a further embodiment, specifically, for a file system with 1,000,000 files, if the changed data rate is 1%, a total backup time may be around 330 seconds, wherein the total backup time contains traversing time of a file system and real data I/O time. In a further embodiment, traversing time of a file system should be less than 330 seconds. In a further embodiment, for sake of easy computing, an approximate value, 300 seconds, may be used as a traversing time of a file system. In a further embodiment, supposing a sampling rate is 5%, a sampling survey time may be calculated as below:

$$Sampling survey time = traversing time for one snapshot \times sampling rate \times snapshots to be traversed = 300 \times 5 \% \times 2 = 30 ( seconds )$$

In a further embodiment, it can be seen that the sampling survey time is around 30 seconds.

In a further embodiment, therefore, Table 3 may be updated, that is, one column may be added to describe time spent in a “smart incremental backup”, so as to compare “smart incremental backup”, legacy incremental backup and fast incremental backup. In a further embodiment, updated Table 3 is as shown in Table 4 below.

TABLE 4

| Changed | | | | | | | | |
|---|---|---|---|---|---|---|---|---|
| Data | | | | | | | Changed | |
| Rate | Seconds | Seconds | Time | Time | Backup | | Data Rate | |
| (%) | (Legacy) | (Fast) | (Smart) | (Fast) | Files | File Size | (%) | |
| Full | 781 | N/A | N/A | 0:13:01 | N/A | 1,040,001 | 33 | GB |
| 1 | 330 | 18 | 48 | 0:05:30 | 0:00:18 | 10,411 | 330 | MB |
| 5 | 373 | 91 | 121 | 0:06:13 | 0:01:31 | 52,001 | 1650 | MB |
| 10 | 402 | 169 | 199 | 0:06:42 | 0:02:49 | 104,001 | 3300 | MB |
| 15 | 420 | 212 | 242 | 0:07:00 | 0:03:32 | 156,001 | 4950 | MB |
| 20 | 447 | 264 | 294 | 0:07:27 | 0:04:24 | 208,001 | 6600 | MB |
| 25 | 455 | 323 | 353 | 0:07:35 | 0:05:23 | 260,001 | 8250 | MB |
| 30 | 483 | 400 | 430 | 0:08:03 | 0:06:40 | 312,001 | 9900 | MB |
| 35 | 499 | 446 | 476 | 0:08:19 | 0:07:26 | 364,001 | 11 | GB |
| 40 | 538 | 506 | 536 | 0:08:58 | 0:08:26 | 416,001 | 13 | GB |
| 45 | 579 | 591 | 609 | 0:09:39 | 0:09:51 | 468,001 | 14 | GB |
| 50 | 576 | 676 | 606 | 0:09:36 | 0:11:16 | 520,001 | 16 | GB |
| 55 | 594 | 722 | 624 | 0:09:54 | 0:12:02 | 572,001 | 18 | GB |
| 60 | 619 | 743 | 649 | 0:10:19 | 0:12:23 | 624,001 | 19 | GB |
| 65 | 642 | 825 | 672 | 0:10:42 | 0:13:45 | 676,001 | 21 | GB |
| 70 | 675 | 906 | 705 | 0:11:15 | 0:15:06 | 728,001 | 23 | GB |
| 75 | 679 | 935 | 709 | 0:11:19 | 0:15:35 | 780,001 | 24 | GB |
| 80 | 705 | 1,034 | 735 | 0:11:45 | 0:17:14 | 832,001 | 26 | GB |
| 85 | 716 | 1,049 | 746 | 0:11:56 | 0:17:29 | 884,001 | 28 | GB |
| 90 | 778 | 1,127 | 808 | 0:12:58 | 0:18:47 | 936,001 | 29 | GB |
| 95 | 770 | 1,172 | 800 | 0:12:50 | 0:19:32 | 988,001 | 31 | GB |
| 100 | 777 | 1,276 | 807 | 0:12:57 | 0:21:16 | 1,040,001 | 33 | GB |

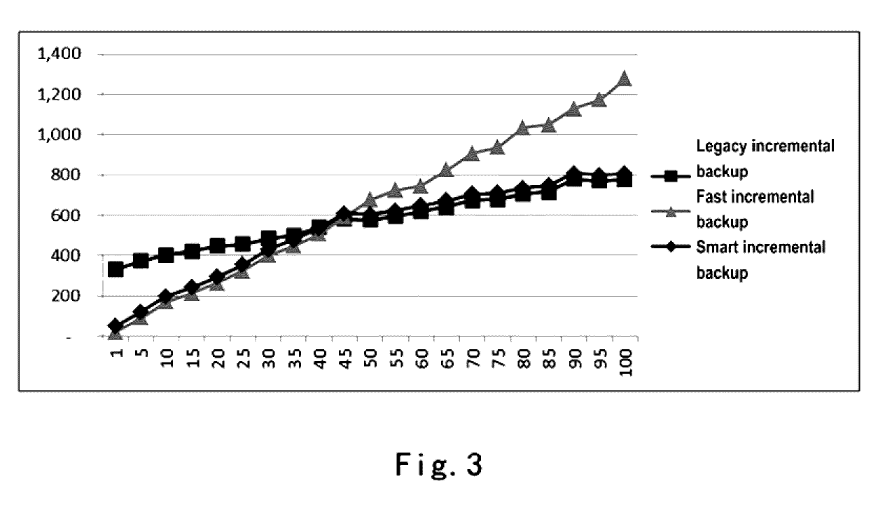

In one embodiment, as seen from Table 4, when the changed data rate is 40% for example, time spent in a smart incremental backup approach (i.e., fast incremental backup on the basis of sampling survey) according to the present disclosure may be about 536 seconds, which is only 30 seconds (sampling survey time) more than time spent in an existing fast incremental backup approach (e.g., 506 seconds as shown in Table 4). In a further embodiment, a smart incremental backup approach according to the present disclosure may achieve a better backup performance with little additional overheads. In a further embodiment in relation to Table 4, FIG. 3 shows a comparison between a smart incremental backup approach according to the present disclosure, a legacy incremental backup approach and a fast incremental backup approach by means of a curve graph. In FIG. 3, the horizontal axis represents a changed data rate of a file system, and the vertical axis represents time cost by a backup. As seen from Table 4, a smart incremental backup approach according to the present disclosure may obtain a better backup performance than a legacy incremental backup approach and a fast incremental backup approach. In addition, in order to further compare an existing fast incremental backup approach and a smart incremental backup approach according to the present disclosure, embodiments of the present disclosure further provide the following examples of pseudo code.

Below is an example of pseudo code for an existing fast incremental backup approach.

```
startIncrementalBackup( )
{
    // Get the configure item to determine the backup method
      if (global_config(run_fast)) {
          // Always run fast incremental if configured
          RunFastIncrementalBackup( );
      } else {
          // Else run legacy incremental
          RunLegacyIncrementalBackup( );
    }
}
RunFastIncrementalBackup( )
{
    // Traverse all snapshots differences
    for (each difference between snap1, snap2) {
        // Traverse files in this difference
        for (each file in difference) {
            if (isNewlyChanged(file)) {
                push(file_list, file);
            }
        }
    }
    // According to the backup format: tar or dump
    // The file_list should be sorted by deep-first-order
    sort(file_list);
    for (each file in file_list) {
        backup(file);
    }
    return OK;
}
```

As seen from the fourth to ninth lines of the above pseudo code, an incremental backup approach is a globally defined configuration item, which can be either configured as a fast incremental backup or a legacy incremental backup. Moreover, a fast incremental backup is always run if configured, and apparently, this method may not flexible enough in many cases.

Below is an example of pseudo code for a smart incremental backup approach according to the present disclosure.

```
startIncrementalBackup( )
{
    // This rate could be configured, 1% for example
    samplingRate = 1%;
    changedRate = quickDetectionWithSampling(snap1, snap2,
    smaplingRate);
    // This rate could be configured, 30% for example
    if (changedRate >= 30%) {
        // Run as legacy incremental backup
        runLegacyIncrementalBackup( );
    } else {
        // Run as fast incremental backup
        runFastIncrementalBackup( );
    }
}
quickDetectionWithSampling(snap1, snap2, samplingRate)
{
    length = snap.length;
    total_count = 0;
    changed_count = 0;
    // Check differences between snaps with samplingRate
    for (i = 0; i < length; i += (length * samplingRate)) {
        difference = getdifference(snap1, snap2, i);
        for (each file in difference) {
            total_count ++;
            if (isNewlyChanged(file)) {
                changed_count ++;
            }
        }
    }
        rate = (change_count / total_count);
    return rate;
},
```

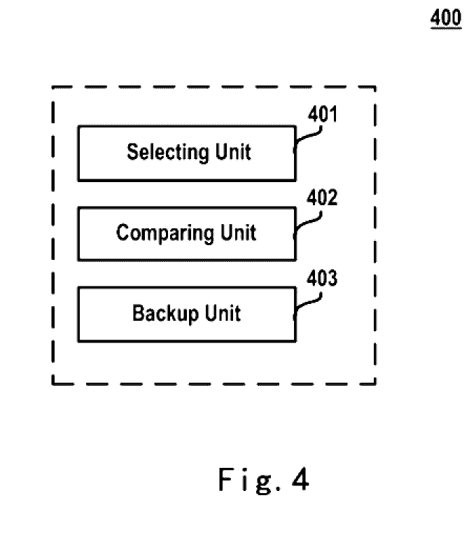

Embodiments of the present disclosure further provide an apparatus for selecting an incremental backup approach. FIG. 4 shows a block diagram of an apparatus 400 for selecting an incremental backup approach according to an embodiment of the present invention. As shown in FIG. 4, apparatus 400 includes: selecting unit 401 configured to select a portion of a current snapshot of a file system; comparing unit 402 configured to compare the selected portion with a portion of a historical snapshot of the file system so as to determine a changed data rate of the file system, wherein the portion of the historical snapshot corresponds to the selected portion; and backup unit 403 configured to select an incremental backup approach based on the changed data rate so as to back up the file system.

In some embodiments, selecting unit 401 may be further configured to randomly select a portion of a current snapshot. In some embodiments, selecting unit 401 may be further configured to: divide data blocks in a current snapshot into a plurality of groups; and randomly select a predetermined number of data blocks in each of the plurality of groups. In some embodiments, selecting unit 401 may be further configured to: divide data blocks in a current snapshot into a plurality of groups; and select one or more data blocks at a predetermined location in each of the plurality of groups.

In some embodiments, backup unit 403 may be further configured to: compare the changed data rate with a predetermined threshold; in response to the changed data rate being greater than a predetermined threshold, select a legacy incremental backup approach to back up a file system; and in response to the changed data rate being less than or equal to a predetermined threshold, select a fast incremental backup approach to back up a file system. In some embodiments, a predetermined threshold may be between 30% and 50%. In some embodiments, a selected portion may include 1% to 10% of a current snapshot.

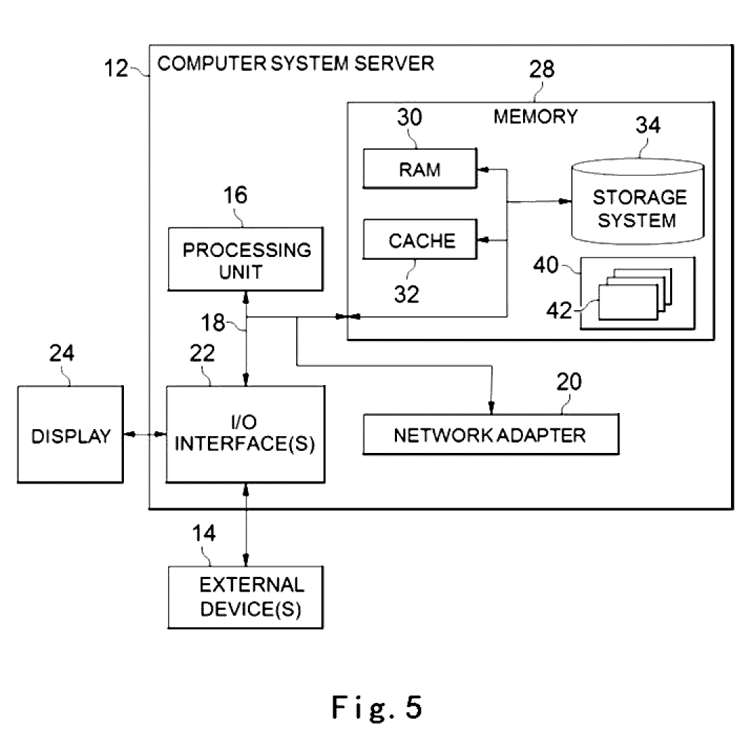

FIG. 5 shows a block diagram of an exemplary computer system/server 12 which is applicable to implement the embodiments of the present invention. Computer system/server 12 shown in FIG. 5 is only illustrative and is not intended to suggest any limitation as to the scope of use or functionality of embodiments of the invention described herein.

As shown in FIG. 5, computer system/server 12 is shown in the form of a general-purpose computing device. The components of computer system/server 12 may include, but are not limited to, one or more processors or processing units 16, system memory 28, and bus 18 that couples various system components (including system memory 28 and processor 16).

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

In particular, according to embodiments of the present invention, the process as described above with reference to FIGS. 1-4 may be implemented as a computer software program. For example, embodiments of the present disclosure include a computer program product, which includes a computer program tangibly embodied on the machine-readable medium. The computer program includes program code for performing methods as disclosed above.

Generally, various exemplary embodiments of the present disclosure may be implemented in hardware or application-specific circuit, software, logic, or in any combination thereof. Some aspects may be implemented in hardware, while other aspects may be implemented in firmware or software executed by a controller, a microprocessor or other computing device. When various aspects of the embodiments of the present disclosure are illustrated or described into block diagrams, flow charts, or other graphical representations, it would be understood that the blocks, apparatus, system, technique or method described here may be implemented, as non-restrictive examples, in hardware, software, firmware, dedicated circuit or logic, common hardware or controller or other computing device, or some combinations thereof.

Besides, each block in the flowchart may be regarded as a method step and/or an operation generated by operating computer program code, and/or understood as a plurality of coupled logic circuit elements performing relevant functions. For example, embodiments of the present disclosure include a computer program product that includes a computer program tangibly embodied on a machine-readable medium, which computer program includes program code configured to implement the method described above.

In the context of the present disclosure, the machine-readable medium may be any tangible medium including or storing a program for or about an instruction executing system, apparatus or device. The machine-readable medium may be a machine-readable signal medium or machine-readable storage medium. The machine-readable medium may include, but not limited to, electronic, magnetic, optical, electro-magnetic, infrared, or semiconductor system, apparatus or device, or any appropriate combination thereof. More detailed examples of the machine-readable storage medium include, an electrical connection having one or more wires, a portable computer magnetic disk, hard drive, random-access memory (RAM), read-only memory (ROM), erasable programmable read-only memory (EPROM or flash memory), optical storage device, magnetic storage device, or any appropriate combination thereof.

The computer program code for implementing the method of the present invention may be written with one or more programming languages. These computer program codes may be provided to a general-purpose computer, a dedicated computer or a processor of other programmable data processing apparatus, such that when the program codes are executed by the computer or other programmable data processing apparatus, the functions/operations prescribed in the flowchart and/or block diagram are caused to be implemented. The program code may be executed completely on a computer, partially on a computer, partially on a computer as an independent software packet and partially on a remote computer, or completely on a remote computer or server.

Besides, although operations are depicted in a particular sequence, it should not be understood that such operations are completed in a particular sequence as shown or in a successive sequence, or all shown operations are executed so as to achieve a desired result. In some cases, multi-task or parallel-processing would be advantageous. Likewise, although the above discussion includes some specific implementation details, they should not be explained as limiting the scope of any invention or claims, but should be explained as a description for a particular embodiment of a particular invention. In the present specification, some features described in the context of separate embodiments may also be integrated into a single embodiment. On the contrary, various features described in the context of a single embodiment may also be separately implemented in a plurality of embodiments or in any suitable sub-group.

Various amendments and alterations to the exemplary embodiments of the present disclosure as above described would become apparent to a person skilled in the relevant art when viewing the above description in connection with the drawings. Any and all amendments still fall within the scope of the non-limiting exemplary embodiments of the present disclosure. Besides, the above description and drawings offer an advantage of teaching, such that technicians relating to the technical field of these embodiments of the present disclosure would envisage other embodiments of the present disclosure as expounded here.

It would be appreciated that the embodiments of the present disclosure are not limited to the specific embodiments as disclosed, and the amendments and other embodiments should all be included within the appended claims. Although particular terms are used herein, they are used only in their general and descriptive sense, rather than for the purpose of limiting.

What is claimed is:

1. A method for incremental backup, the method comprising:
selecting a portion of a current snapshot of a file system;
comparing the selected portion with a portion of a historical snapshot of the file system to determine a changed data rate of the file system, the portion of the historical snapshot corresponding to the selected portion; and
selecting an incremental backup approach based on the changed data rate for performing a backup of the file system.

2. The method according to claim 1, wherein the step of selecting a portion of the current snapshot of the file system comprises:
randomly selecting the portion of the current snapshot.

3. The method according to claim 2, further comprises:
dividing data blocks in the current snapshot into a plurality of groups; and
randomly selecting a predetermined number of data blocks from each of the plurality of groups.

4. The method according to claim 1, wherein the step of selecting a portion of the current snapshot of the file system comprises:
dividing data blocks in the current snapshot into a plurality of groups; and
selecting one or more data blocks at a predetermined location in each of the plurality of groups.

5. The method according to claim 1, wherein the step of selecting an incremental backup approach based on the changed data rate for backup of the file system comprises:
comparing the changed data rate with a predetermined threshold;
selecting at least one of
in response to the changed data rate being greater than the predetermined threshold, selecting a legacy incremental backup approach for the backup of the file system; and
in response to the changed data rate being less than or equal to the predetermined threshold, selecting a fast incremental backup approach for the backup of the file system.

6. The method according to claim 5, wherein the predetermined threshold is between 30% and 50%.

7. The method according to claim 1, wherein the selected portion includes 1% to 10% of the current snapshot.

8. An apparatus for incremental backup configured to:
select a portion of a current snapshot of a file system;
compare the selected portion with a portion of a historical snapshot of the file system to determine a changed data rate of the file system, the portion of the historical snapshot corresponding to the selected portion; and
select an incremental backup approach based on the changed data rate for performing a backup of the file system.

9. The apparatus according to claim 8, further configured to:
randomly select the portion of the current snapshot.

10. The apparatus according to claim 9, further configured to:
divide data blocks in the current snapshot into a plurality of groups; and
randomly select a predetermined number of data blocks in each of the plurality of groups.

11. The apparatus according to claim 8, further configured to:
divide data blocks in the current snapshot into a plurality of groups; and
select one or more data blocks at a predetermined location in each of the plurality of groups.

12. The apparatus according to claim 8, further configured to:
compare the changed data rate with a predetermined threshold;
selecting at least one of:
in response to the changed data rate being greater than the predetermined threshold, select a legacy incremental backup approach for the backup of the file system; and
in response to the changed data rate being less than or equal to the predetermined threshold, select a fast incremental backup approach for the backup of the file system.

13. The apparatus according to claim 12, wherein the predetermined threshold is between 30% and 50%.

14. The apparatus according claim 8, wherein the selected portion includes 1% to 10% of the current snapshot.

15. A computer program product, comprising a computer readable medium, the computer readable medium carrying computer program code embodied therein and for use with a computer, the computer program code configured for:
selecting a portion of a current snapshot of a file system;
comparing the selected portion with a portion of a historical snapshot of the file system to determine a changed data rate of the file system, the portion of the historical snapshot corresponding to the selected portion; and
selecting an incremental backup approach based on the changed data rate for performing backup of the file system.
